(19) United States
(12) Patent Application Publication
(10) Pub. No.: US 2004/0001088 A1
(43) Pub. Date: Jan. 1, 2004

(54) Portable electronic key providing transportable personal computing environment

(75) Inventors: Charles J. Stancil, Tomball, TX (US); Randall W. Martin, The woodlands, TX (US); Kenneth B. Williams, The Woodlands, TX (US); Thomas R. Gawlik, Houston, TX (US); Wayne P. Sharum, Spring, TX (US); Craig Walrath, Spring, TX (US); Ernest Hood, Tomball, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Compaq Information Technologies Group, L.P., Houston, TX

(21) Appl. No.: 10/185,516

(22) Filed: Jun. 28, 2002

(51) Int. Cl. G09G 5/00

(52) U.S. Cl. 345/748; 345/864

(57) ABSTRACT

A portable personal configuration device contains non-volatile memory and can be used to quickly and efficiently transport a user's personalized computing environment from one computer to another. The portable personal configuration device preferably is USB-compatible and thus plugs into a USB port in any computing device. In one embodiment, one or more files representing the user's computing environment are downloaded to the portable device and can then be uploaded to a different computer once connected to such new computer. Alternatively, the portable device can cause the computer's web browser to access a particular website containing the user's personalized computing environment which can then be readily downloaded to the computer. In this latter embodiment, the user's computing environment data is maintained on the web and once the portable device is plugged into a computer, the computer is caused to download the user's computing environment from the web.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention generally relates to transporting a computing environment from one computer to another. More particularly, the invention relates to the use of a portable electronic key to transport a computing environment from one computer to another. Still more particularly, the invention relates to the use of a USB portable device to store computing environment information from one computer via a USB port and upload the information via a USB port of another computer.

2. Background Information

As is commonly understood, personal computers provide a multitude of features and functions besides simply applications (word processing, spreadsheets, etc.). Such features and functions include such things as Internet “favorites,” email “contacts,” cookies, digital signatures, the background image associated with the desktop, the icons that appear on the desk, and the like. Such features and functions are colloquially referred to as the “computing environment.”

A user of a computer also can create and change the computing environment for the computer. Each person may prefer to see a certain set of icons on the desktop, a certain background image, have a certain set of contacts, etc. That is, the computing environment one person prefers generally differs from the computing environment of other people.

The ability for a user to customize the computing environment is highly desirable and currently possible in computer systems. A problem occurs, however, if a user obtains a new computer or switches to an existing computer of another user. Either way, the new computer may, and likely will, have a computing environment that is different from what the user is accustomed to and may not be desirable to the user. Currently, this problem is resolved by the user manually reconfiguring the computer to his or her desirable environment. This process entails numerous time-consuming actions such as changing the background image, changing or creating a new set of icons on the desktop, uploading or entering a new set of contacts and favorites, and the like. Although recreating the user's computing environment can be done manually, it is a time consuming, tiring, and thus inconvenient process. A solution to this problem is needed.

### BRIEF SUMMARY OF THE PREFERRED EMBODIMENTS OF THE INVENTION

The problems noted above are solved in large part by applying a computer system that includes a portable personal configuration device which can be electrically mated with the computer. The portable personal configuration device contains non-volatile memory and can be used to quickly and efficiently transport a user's personalized computing environment from one computer to another. The portable personal configuration device preferably is USB-compatible and thus plugs into a USB port in any computing device (e.g., desktop, notebook, etc.).

In accordance with the one embodiment, one or more files representing the user's computing environment are downloaded to the portable device and can then be uploaded to a different computer once connected to such new computer. Alternatively, the portable device can cause the computer's web browser to access a particular website containing the user's personalized computing environment which can then be readily downloaded to the computer. In this embodiment, the user's computing environment data is maintained on the web and once the portable device is plugged into a computer, the computer is caused to download the user's computing environment from the web.

These and other aspects of the present invention will become apparent upon analyzing the drawings, detailed description and claims, which follow.

### BRIEF DESCRIPTION OF THE DRAWINGS

For a detailed description of the preferred embodiments of the invention, reference will now be made to the accompanying drawings in which:

FIG. 1 shows a preferred embodiment of the invention comprising a computer system and a portable electronic key that permits the computing environment from one computer to be transported to another computer; and

FIG. 2 shows a block diagram of the preferred embodiment depicted in FIG. 1.

### NOTATION AND NOMENCLATURE

Certain terms are used throughout the following description and claims to refer to particular system components. As one skilled in the art will appreciate, computer companies may refer to a component and sub-components by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either a direct or indirect electrical connection. Thus, if a first device couples to a second device, that connection may be through a direct electrical connection, or through an indirect electrical connection via other devices and connections. In addition, no distinction is made between a “processor,” “microprocessor,” “microcontroller,” or “central processing unit” (“CPU”) for purposes of this disclosure. To the extent that any term is not specially defined in this specification, the intent is that the term is to be given its plain and ordinary meaning.

### DETAILED DESCRIPTION OF THE PREFERRED EMBODIMENTS

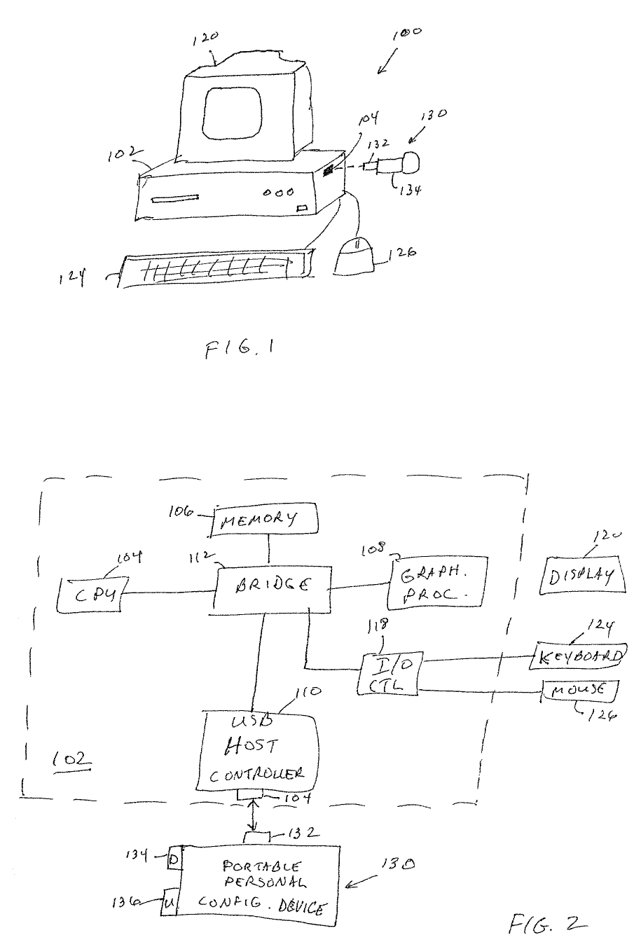

Referring now to FIG. 1, computer system 100 constructed in accordance with the preferred embodiment comprises a processor box 102, a display 120, a keyboard 124, a mouse (or other pointing device) 126 and a portable personal configuration device 130. The portable personal configuration device 130 mates with the processor box 102 via connectors 104 and 132 as shown. The portable personal configuration device preferably comprises the connector 132 and a housing 134 which contains non-volatile memory and other electronics as noted below.

In general, computing environment information can be stored in the non-volatile memory in the portable personal configuration device 130. The portable personal configuration device can then be taken to another computer system, connected thereto, and the computing environment information can be uploaded into the new computer to cause the new computer to be set up with the user's computing environment. In this context, the portable personal configuration device 130 comprises a portable storage device, unlike a floppy disk in that the portable personal configuration device preferably includes solid state memory for its storage medium and does not require a “disk drive” to access the data contained therein.

FIG. 2 shows a block diagram of computer system 100 in accordance with a preferred embodiment. As shown, system 100 preferably comprises a CPU 104, a memory 106, a graphics processor 108, a host controller 110, and an input/output (“I/O”) controller 118 coupled to a bridge 112. The keyboard 124 and mouse 126 couple to the CPU 104 via the I/O controller 118 and bridge 112 as shown. The graphics processor 108 couples to and drives display 120 and comprises any suitable type of graphics accelerator device. Similarly, the CPU 104 preferably comprises any suitable processor device such as a Pentium® processor from Intel® or comparable device from AMD or other manufacturers. The components depicted in the preferred embodiment of FIG. 2 can be arranged in numerous other ways. Further, different or additional components can be provided. The computer system 100 of FIG. 2 is simply intended to be indicative of any type of computing device such as a desktop computer, notebook computer, handheld computer, etc.

The portable personal configuration device 130 communicates with the computer via any suitable type of communication link. In accordance with the preferred embodiment of FIG. 2, the communication link comprises a Universal Serial Bus (“USB”). As such, the host controller 110 comprises a USB host controller and connectors 104 and 132 preferably comprise USB connectors. USB is a communication protocol that is well-known to those of ordinary skill in the art and thus is not described in detail herein. An advantageous feature of USB is that USB devices can connect to the system while the system is powered on. This feature is typically referred to as “plug & play.”

The portable personal configuration device 130 preferably includes solid state memory storage such as in the form of “flash” memory and a USB hub interface. The memory capacity of the portable personal configuration device 130 can be any capacity sufficient to stored the computing environment information and any executable code or other information desired. Other components may be included as well. Suitable examples of USB-based portable personal configuration devices include the ThumbDrive by Trek and the DiskOnKey by M-Systems modified in accordance with known techniques to provide the functionality described herein. Such devices have 8 megabytes and higher of memory capacity, although a portable personal configuration device with less than 8 megabytes of memory capacity is acceptable as well.

In general, the CPU 104 coordinates the transfer of data between memory 106 in the computer and the memory in the portable personal configuration device 130. In accordance with one embodiment, the data transferred to the portable personal configuration device includes the computer's computing environment information. Such information may be downloaded to the configuration device 130 in the form of a single file, multiple files or in accordance with other forms, formats, and/or data representations. The computing environment information may include any one or more, or all, of the following types data:

Internet favorites

Internet cookies

Contacts

Calendar information

Digital certificates

Software keys (to activate application software stored on computer)

Passwords

Digital Rights Management Tokens (audio, video)

Desktop background image

Desktop icons

Toolbar configuration

Audio configuration information

Graphics configuration information

Game settings

The above list is not exhaustive of all of the environment information that can be stored on the portable personal configuration device. The specific list of computing environment data can be preset or programmed by a user of the computer using a utility application which provides the user a selectable list of environment data parameters. The user can then select or deselect the environment data parameters to be used.

When the user wishes to download the computing environment from his or her currently used computer, the user initiates such process in accordance with any suitable manner. For example, the user could simply plug the portable personal configuration device 130 into the computer. The host computer would then recognize the presence of the device 130 in accordance with conventional USB plug & play techniques. At that point, the computer preferably downloads the computing environment data to the device's memory.

Alternatively, the portable personal configuration device 130 may include a download initiation button 134. Once pressed, the download initiation button 134 causes the portable personal configuration device 130 to request the computing environment data from the computer's memory 106. Further still, the button 134 can be provided on the computer box 102 rather than on the portable personal configuration device 130.

Regardless of how the download process is initiated, the computing environment data is stored in the memory of the portable personal configuration device 130. Once stored therein, the user can carry the portable personal configuration device 130 to another computer, mate the portable personal configuration device with such other computer and cause the computing environment data to be uploaded into the new computer. Uploading can be initiated either automatically upon insertion of the device 130 into the new computer or by the user pressing an upload button 136 on the device itself.

At least some operating systems have the capability of accommodating multiple users each having a different computing environment. An example of such operating systems include, without limitation, Windows XP. Thus, when a portable personal configuration device 130 is mated with a computer and begins to upload the user's computing environment data, the device 130 preferably creates a user setting in which to upload the environment data. Alternatively, if the user setting was previously created on the computer, the device 130 copies its environment data file(s) over the previous environment data file(s) already established for that user on the computer.

Instead of storing a user's personalized computing environment data in the portable personal configuration device 130, in accordance with another embodiment, the user's computing environment could be stored on the web at a predetermined website. In this embodiment the a portable personal configuration device preferably is programmed with the Internet Protocol (“IP”) address or Uniform Resource Locator (“URL”) of the website containing the computing environment file(s). Further, the portable personal configuration device 130 preferably contains autoexecuting code which can cause web browser software in the computer to access the website. Accordingly, when a user plugs the portable personal configuration device 130 into a computer, the portable personal configuration device provides the IP address or URL of the website to the computer's web browser. In response, the computer establishes communication with the website and downloads the user's computing environment data.

Further, the website may store computing environment data associated with a plurality of users. A value unique to the user could be stored in the portable personal configuration device. The value could be the user's name, a unique number, or other identifying parameter. This user-unique value could be provided to the computer's web browser and thus to the website to permit the website to download the computing environment associated with the correct user.

The portable personal configuration device 130 can also be equipped with any well-known fingerprint device to provide extra security. A fingerprint template associated with the user could be pre-programmed into the portable personal configuration device and be used to determine if the operator of the portable personal configuration device is authorized. If the operator's fingerprint does not match the previously stored fingerprint, the portable personal configuration device and/or the computer could be programmed not to upload or download any computing environment data.

The portable personal configuration device 130 described above thus permits a user to easily and efficiently transport his or her personalized computing environment from one computer to another. The portable personal configuration device also permits other desirable benefits. For example, the portable personal configuration device can be used as a system restore device in the event the computer system crashes. If the system crashes, the user could plug in the portable personal configuration device and cause the system to reboot. The system would then boot from the portable personal configuration device, similar to the way in which conventional computer systems boot from a floppy disk. The non-volatile memory in the portable personal configuration device, however, has a much higher capacity than a floppy disk and thus can store much more system information such as complete system registry, safe mode restore, system configuration and boot files, complete system restore, hardware device configuration, system hardware and software component list, restore files, key drivers, personal settings, etc. This provides a system recovery option that can restore the system either to a full restore state with everything working properly or at least to a state with most of the system functioning properly, unlike the system recovery permitted by booting from a floppy drive.

Another use of the portable personal configuration device 130 is to accommodate a “dynamic coupon.” When a user purchases the portable personal configuration device, the device could be preloaded with a coupon entitling the user to a discount on an Internet-based purchase. Thus, when the user goes to purchase the associated item, the on-line vendor could determine, in accordance with well-known techniques, whether the portable personal configuration device is present and whether the coupon is still valid. If both conditions are true, the user preferably is given the discount. Once the discount is given, the on-line vendor service or the user's computer could invalidate the coupon on the portable personal configuration device preventing it from being used again. Invalidating the coupon could include simply erasing the coupon information or setting a bit in the device indicating whether the coupon is valid or invalid. Further still, the online vendor could, at the time of purchase or later, reset the coupon on the portable personal configuration device to the same or different discount value.

Yet another use of the portable personal configuration device 130 is to permit the user to play games on the computer. In this embodiment, a game is stored in the portable device's memory thereby permitting the user to play the game on any computer to which the device is mated. Further still, as is well-known the settings of many games can be saved to a hard disk drive thereby permitting a user to stop playing a game and later continue playing the game from the point at which the user last played the game. With the portable personal configuration device, the current game settings can be stored on the device thereby permitting the user to continue the game from where he or she left off. Further, the device's portability permits the user to continue playing the game from the same point on a different computer. Further still, the game application itself could be stored on the portable personal configuration device, on the computer's hard drive or on a web site. If the game is not stored on the portable personal configuration device 130, the game settings could be stored on the portable personal configuration device. The game further could be autorun from the portable personal configuration device with automatic game setting enabling and saving.

The portable configuration device 130 may also be equipped with an application starter. An application starter is an executable code that runs automatically when, for example, a CD is loaded into a CD drive or, as in the present case, the portable device is connected to the host computer. The starter causes a predetermined application to begin running without user involvement, other than connecting the portable device to the computer. Application starters are well known in the art. As such, a game preloaded on the device 130 could start playing as soon as the device 130 is connected to the computer. Further, as noted above, the previously saved game settings could be retrieved thereby permitting the user to continue playing the game with minimal effort. Any type of application stored on the device 130 could be caused to auto run as desired. Examples include, without limitation, games, advertisements, demonstrations, etc.

The above discussion is meant to be illustrative of the principles and various embodiments of the present invention. Numerous variations and modifications will become apparent to those skilled in the art once the above disclosure is fully appreciated. For example, the portable storage device may have a wireless link to the computer rather than a wired connection as depicted in the figures. Further, digital interfaces besides USB can be used such as PCMCIA. It is intended that the following claims be interpreted to embrace all such variations and modifications.

What is claimed is:

1. A portable personal configuration device connectable to a plurality of computing device, comprising:
non-volatile memory; and
an interface to a computing device;
wherein said non-volatile memory contains a user's personalized computing environment data.

2. The device of claim 1 wherein said personalized computing environment data comprises at least one type of information selected from the group consisting of desktop background image, desktop icons, contacts, calendar information, passwords, digital signatures, Internet favorites, Internet cookies, and game settings.

3. The device of claim 1 wherein said interface comprises a USB interface.

4. The device of claim 1 wherein said non-volatile memory is readable and writeable and contains autoexecuting code.

5. The device of claim 1 further comprising a fingerprint identification device.

6. The device of claim 5 wherein said non-volatile memory contains a fingerprint template of the user and wherein the personalized computing environment data associated with the user is only accessible if the fingerprint of the person operating the device matches the template.

7. A portable personal configuration device connectable to a plurality of computing device, comprising:
non-volatile memory; and
an interface to a computing device;
wherein said non-volatile memory contains a link to a website containing personalized computing environment data.

8. The portable personal configuration device of claim 7 wherein said portable personal configuration device causes said computing environment data to be downloaded to an attached computing device.

9. The portable personal configuration device of claim 8 wherein personalized computing environment data comprises at least one type of information selected from the group consisting of desktop background image, desktop icons, contacts, calendar information, passwords, digital signatures, Internet favorites, Internet cookies, and game settings.

10. The device of claim 7 wherein said non-volatile memory also contains a value that uniquely identifies a user, said value being transmitted to the website and the personalized computing environment data associated with said user is downloaded to a computer to which the device connects.

11. The device of claim 10 further comprising a fingerprint identification device.

12. The device of claim 11 wherein said non-volatile memory contains a fingerprint template of the user and wherein the personalized computing environment data associated with the user is only downloaded to the computer if the fingerprint of the person operating the device matches the template.

13. The device of claim 7 further comprising a fingerprint identification device.

14. The device of claim 13 wherein said non-volatile memory contains a fingerprint template of the user and wherein the personalized computing environment data associated with the user is only downloaded to the computer if the fingerprint of the person operating the device matches the template.

15. A computer system, comprising:
a CPU;
volatile memory coupled to said CPU; and
a portable configuration device coupled to said CPU, said portable configuration device comprising non-volatile memory, wherein said non-volatile memory contains a user's personalized computing environment data.

16. The computer system of claim 15 wherein said personalized computing environment data comprises at least one type of information selected from the group consisting of desktop background image, desktop icons, contacts, calendar information, passwords, digital signatures, Internet favorites, Internet cookies.

17. The computer system of claim 15 wherein said portable configuration device couples to said CPU via a USB interface.

18. The computer system of claim 15 wherein said non-volatile memory is readable and writeable and contains autoexecuting code.

19. The computer system of claim 15 further comprising a fingerprint identification device.

20. The computer system of claim 19 wherein said non-volatile memory contains a fingerprint template of the user and wherein the personalized computing environment data associated with the user is only accessible if the fingerprint of the person operating the device matches the template.

21. A computer system, comprising:
a CPU;
volatile memory coupled to said CPU; and
portable configuration device coupled to said CPU, said portable configuration device comprising non-volatile memory, wherein said non-volatile memory contains a link to a website containing personalized computing environment data.

22. The computer system of claim 21 wherein said non-volatile memory also contains a value that uniquely identifies a user, said value being transmitted to the website and the personalized computing environment data associated with said user is downloaded to a computer to which the device connects.

23. The computer system of claim 22 further comprising a fingerprint identification device.

24. The computer system of claim 23 wherein said non-volatile memory contains a fingerprint template of the user and wherein the personalized computing environment data associated with the user is only downloaded to the computer if the fingerprint of the person operating the device matches the template.

25. The computer system of claim 21 further comprising a fingerprint identification device.

26. The computer system of claim 25 wherein said non-volatile memory contains a fingerprint template of the user and wherein the personalized computing environment data associated with the user is only downloaded to the computer if the fingerprint of the person operating the device matches the template.

27. A method of transporting a user's computing environment from one computer to another computer, comprising:
(a) copying, from one computer, computing environment data to non-volatile, solid state memory contained in a portable device;
(b) decoupling the portable device from the computer in (a);
(c) coupling the portable device to another computer; and
(d) copying the computing environment data from the portable device's solid state memory to the computer in (c).

28. The method of claim 27 wherein said portable device couples to the computers in (a) and (c) via a USB interface.

29. The method of claim 27 wherein said computing environment data comprises at least one type of information selected from the group consisting of desktop background image, desktop icons, contacts, calendar information, passwords, digital signatures, Internet favorites, Internet cookies.

30. A method of transporting a user's computing environment from one computer to another computer, comprising:
(a) coupling a portable electronic device to a computer;
(b) accessing a website using website location information stored in said portable electronic device; and
(c) copying computing environment data from the website to the computer.

31. The method of claim 30 wherein said portable device couples to the computers in (a) and (c) via a USB interface.

32. The method of claim 30 wherein said computing environment data comprises at least one type of information selected from the group consisting of desktop background image, desktop icons, contacts, calendar information, passwords, digital signatures, Internet favorites, Internet cookies.

33. A computer system, comprising:
a CPU;
a display coupled to said CPU;
an input control device coupled to said CPU; and
a portable storage device coupled to said CPU, said portable storage device containing solid state memory in which configuration data pertaining to a user of said computer system is stored, and said portable storage device capable of being coupled to a CPU of a different computer system to install the configuration data in said different computer system.

34. The computer system of claim 33 wherein said portable storage device includes a USB interface to computer system.

35. The computer system of claim 34 wherein said portable storage device includes a download button that, when activated, causes the CPU to download said configuration data to said solid state memory.

36. The computer system of claim 34 wherein said portable storage device includes an upload button that, when activated, causes the solid state memory to upload said configuration data to said CPU of the computer to which the portable storage device is coupled.

37. The computer system of claim 34 wherein said configuration data comprises game settings.

38. A portable personal configuration device connectable to a plurality of computing devices, comprising:
non-volatile memory; and
an interface to a computing device;
wherein said non-volatile memory contains a digital coupon which provides a discount to a user of said portable personal configuration when making an on-line purchase.

39. The portable personal configuration device of claim 38 wherein said digital coupon can be dynamically replenished.
